(19) United States
(12) Patent Application Publication
(10) Pub. No.: US 2026/0121100 A1
(43) Pub. Date: Apr. 30, 2026

(54) SECONDARY BATTERY MANUFACTURING DEVICE

(71) Applicant: SK On Co., Ltd., Seoul (KR)

(72) Inventors: Hyung Gi KIM, Daejeon (KR); Seung Han LEE, Daejeon (KR)

(21) Appl. No.: 19/333,344

(22) Filed: Sep. 19, 2025

(30) Foreign Application Priority Data
Oct. 28, 2024 (KR) 10-2024-0148581

(51) Int. Cl. H01M 10/04; H02K 7/06; H02K 13/00

(52) U.S. Cl. CPC H01M 10/0404; H02K 7/06; H02K 13/003

(57) ABSTRACT

A secondary battery manufacturing device is disclosed. According to the present disclosure, there is provided a secondary battery manufacturing device including a carrier on which the electrode assembly is seated and disposed, and an alignment device selectively coupled to the carrier to align a position of the electrode assembly. The present disclosure relates to transferring an electrode assembly in a secondary battery manufacturing process.

### CROSS-REFERENCE TO RELATED APPLICATION

This application claims priority to and the benefit of Korean Patent Application No. 10-2024-0148581, filed on Oct. 28, 2024, the disclosure of which is incorporated herein by reference in its entirety.

### BACKGROUND

### 1. Field of the Invention

Embodiments of the present disclosure relate to a secondary battery manufacturing device.

### 2. Discussion of Related Art

A secondary battery is one of the energy storage means which can be charged and discharged through electrochemical reactions. The secondary battery may be utilized in various fields in which electrical energy is used. For example, secondary batteries are widely utilized in the field of mobile devices such as a cell phone, a notebook, a tablet, and the like, and are being explored for wider utilization in the field of transportation means such as vehicles, aircraft, ships, and the like. Further, demand for secondary batteries is increasing in the field of energy storage systems (ESSs) for utilizing surplus electricity.

As the demand for secondary batteries increases in various fields, secondary batteries are being mass-produced through automated lines. A secondary battery manufacturing device may be provided such that each process operation is sequentially performed while transferring components such as electrode assemblies along a process line. The effective transfer or alignment of electrode assembly in the secondary battery manufacturing device may have a direct effect on process efficiency or processing quality.

### SUMMARY OF THE INVENTION

Embodiments of the present disclosure are directed to providing a secondary battery manufacturing device.

In addition, some embodiments of the present disclosure are directed to providing a secondary battery manufacturing device that may be used for transferring an electrode assembly in a secondary battery manufacturing process.

In addition, some embodiments of the present disclosure are directed to providing a secondary battery manufacturing device capable of aligning the position of an electrode assembly in an electrode assembly manufacturing process.

In addition, some embodiments of the present disclosure are directed to providing a secondary battery manufacturing device capable of preventing damage to an electrode assembly in an electrode assembly manufacturing process.

Some embodiments of the present disclosure may be widely applied in the field of green technologies such as an electric vehicle and a battery charging station as well as solar power generation and wind power generation using batteries. Further, some embodiments of the present disclosure may be used in an eco-friendly electric vehicle, a hybrid vehicle, and the like to prevent climate changes by suppressing air pollution and greenhouse gas emissions.

According to one aspect of the present disclosure, there is provided a secondary battery manufacturing device including a carrier on which the electrode assembly is seated and disposed, and an alignment device selectively coupled to the carrier to align a position of the electrode assembly.

In some embodiments, the carrier may include a first panel on which the electrode assembly is seated and a second panel sandwiching the electrode assembly between the first panel and the second panel.

In some embodiments, the first panel may be provided to be laterally movable relative to the second panel.

In some embodiments, the second panel may be provided to be vertically movable relative to the first panel.

In some embodiments, the second panel may be elastically supported toward the first panel so as to elastically support the electrode assembly between the first panel and the second panel.

In some embodiments, the carrier may include a ball screw connected to the first panel through a link and moving the first panel laterally.

In some embodiments, the carrier may include a preload unit that comes into frictional contact with an outer surface of the ball screw to partially restrict the rotation of the ball screw.

In some embodiments, the preload unit may include first and second preload unit bodies coupled through a hinge shaft and clamping the outer surface of the ball screw, a second spring elastically supporting the first preload unit body toward the outer surface of the ball screw, and an adjusting bolt and an adjusting nut that regulate a position of the second preload unit body to adjust a frictional force applied to the outer surface of the ball screw.

In some embodiments, the carrier may include a socket selectively coupled to the alignment device and transmitting a rotational driving force to the ball screw.

In some embodiments, the carrier may include a first base supporting a first panel on which the electrode assembly is seated and a second base supporting a second panel that sandwiches the electrode assembly between the first panel and the second panel.

In some embodiments, the second base may be provided to be movable relative to the alignment device.

In some embodiments, the alignment device may be provided to be movable forward and backward toward/from the carrier, and may be selectively coupled to the carrier.

In some embodiments, the alignment device may include an electromagnet selectively magnetically coupled to a socket of a ball screw provided in the carrier. In some embodiments, the alignment device may include a rotating shaft that rotates the electromagnet so that the ball screw rotates about a longitudinal direction as an axis.

In some embodiments, the rotating shaft may be provided with a wiring path therein to supply power to the electromagnet.

In some embodiments, the alignment device may include a slip ring provided on the rotating shaft, and the slip ring may include a rotating portion that rotates in conjunction with the rotating shaft and a fixed portion that rotatably supports the rotating portion.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a secondary battery manufacturing device according to one embodiment of the present disclosure;

FIG. 2 is an exploded perspective view of a carrier shown in FIG. 1;

FIG. 3 is a perspective view of the carrier shown in FIG. 2 viewed from a different direction;

FIG. 4 is an enlarged view of a preload unit shown in FIG. 3;

FIG. 5 is an exploded perspective view of an alignment device shown in FIG. 1;

FIG. 6 is a perspective view of the alignment device shown in FIG. 5 viewed from a different direction;

FIG. 7 is a longitudinal-sectional view of the secondary battery manufacturing device shown in FIG. 1; and

FIGS. 8 to 10 are operational state views of the secondary battery manufacturing apparatus shown in FIG. 1.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

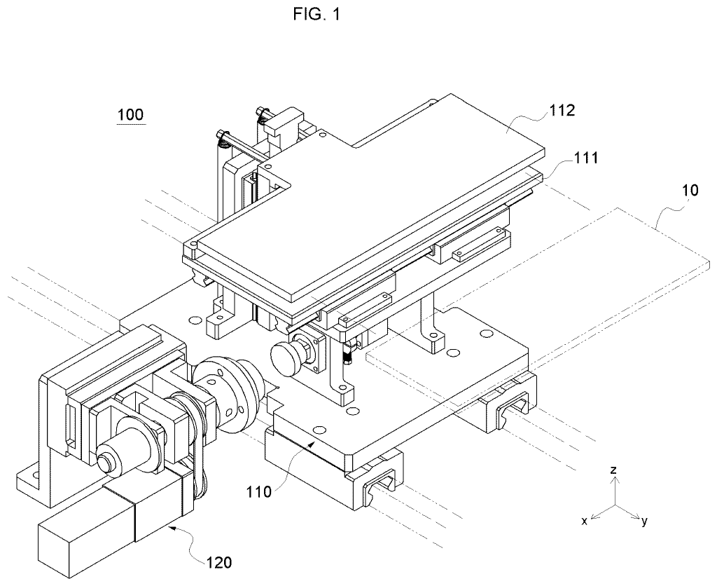

FIG. 1 is a perspective view of a secondary battery manufacturing device according to one embodiment of the present disclosure.

For convenience, hereinafter, the X-axis direction will be referred to as a left-right direction, the Y-axis direction will be referred to as a front-rear direction, and the Z-axis direction will be referred to as an up-down direction based on the coordinate axes shown in FIG. 1 and the like.

Referring to FIG. 1, embodiments of the present disclosure may provide a secondary battery manufacturing device 100. In some embodiments, the secondary battery manufacturing device 100 may be used for transferring an electrode assembly 10. That is, the electrode assembly 10 may be disposed in the secondary battery manufacturing device 100 as in the illustrated embodiment and transferred to each process operation. As will be described below, the secondary battery manufacturing device 100 may transfer the electrode assembly 10 to each process operation and may be provided to align the position of the disposed electrode assembly 10.

In some embodiments, the electrode assembly 10 may be provided in the form of a sheet having a predetermined width in each of a left-right direction and a front-rear direction. In the illustrated embodiment, the electrode assembly 10 is exemplified as a rectangular sheet in which long sides are disposed in the left-right direction. However, the specific shape, specifications, and the like of the electrode assembly 10 may be variously modified as needed, and are not necessarily limited to those exemplified.

In some embodiments, the electrode assembly 10 may be provided in the form of a flexible sheet that may be bent by physical contact. In some embodiments, the secondary battery manufacturing device 100 may perform more effective positional alignment for the electrode assembly 10 in the form of a flexible sheet. For example, the secondary battery manufacturing device 100 may perform positional alignment for the flexible sheet-shaped electrode assembly 10 by moving the panel itself, for the flexible sheet-shaped electrode assembly 10 as described below. This method may contribute to preventing electrode damage or misalignment by reducing the physical contact with the electrode assembly 10. This will be described in detail with respect to configurations of the secondary battery manufacturing device 100 to be described below.

In some embodiments, the electrode assembly 10 may be provided with electrodes coated on one or both surfaces of the substrate. However, in the present embodiment, the detailed configuration of the electrode assembly 10 is not particularly limited. In addition, the secondary battery manufacturing device 100 of the present embodiment is for transferring an electrode assembly 10 being processed, and the term “electrode assembly 10” may be used broadly to encompass an electrode assembly 10 being processed. That is, in the present description, the electrode assembly 10 may include an electrode assembly 10 in a state where some components are omitted or before being processed.

Meanwhile, the secondary battery manufacturing device 100 may include a carrier 110 in which the electrode assembly 10 is seated and disposed and an alignment device 120 selectively coupled to the carrier 110 to align the position of the electrode assembly 10.

Specifically, in some embodiments, the secondary battery manufacturing device 100 may include the carrier 110. The carrier 110 may be provided such that the electrode assembly 10 for processing is seated. In the illustrated embodiment, the carrier 110 is provided with first and second panels 111 and 112 disposed vertically, and the electrode assembly 10 is provided to be seated on the first panel 111 and supported between the first and second panels 111 and 112.

The electrode assembly 10 may be transferred to each process operation while seated on the carrier 110. In addition, the transferred electrode assembly 10 may undergo a predetermined processing process according to each process operation. In the illustrated embodiment, the carrier 110 is exemplified as moving in the front-rear direction corresponding to the Y-axis direction. Of course, the direction of movement of the carrier 110 may be variously modified as needed, and is not necessarily limited to the examples.

In some embodiments, the electrode assembly 10 may be aligned in its predetermined position before processing. In some cases, the positional alignment of the electrode assembly 10 may be performed before processing in each process operation, or in some of a plurality of process operations. As will be described below, in some embodiments, the positional alignment of the electrode assembly 10 may be implemented through the movement of the first panel 111 on which the electrode assembly 10 is seated. That is, the secondary battery manufacturing device 100 may be provided to align the position of the electrode assembly 10 through a method of moving the first panel 111, rather than a method of bringing a separate alignment device into contact with the electrode assembly 10 to align its position. This method may contribute to preventing electrode damage or misalignment by reducing the physical contact with the electrode assembly 10 while processing.

Meanwhile, in some embodiments, the secondary battery manufacturing device 100 may include the alignment device 120. The alignment device 120 may be provided to align the position of the electrode assembly 10. Specifically, the alignment device 120 may be provided to align the position of the electrode assembly 10 by moving the first panel 111 on which the electrode assembly 10 is seated. In the illustrated embodiment, the alignment device 120 may be provided to align the left-right position of the electrode assembly 10 by moving the first panel 111 in the left-right direction. For reference, the front-rear position of the electrode assembly 10 may be adjusted through movement of the carrier 110 in the front-rear direction.

In some embodiments, the alignment device 120 may be selectively coupled to the carrier 110. That is, the alignment device 120 may be coupled to the carrier 110 or separably provided from the carrier 110. In the illustrated embodiment, the carrier 110 is illustrated as moving in the front-rear direction, and the alignment device 120 may be provided to move left and right on one side of the carrier 110 so as to be coupled to the carrier 110 or detached from the carrier 110.

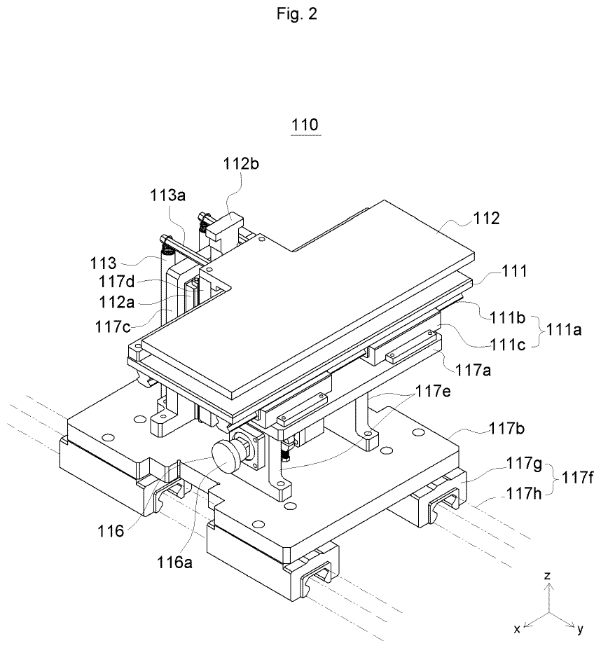

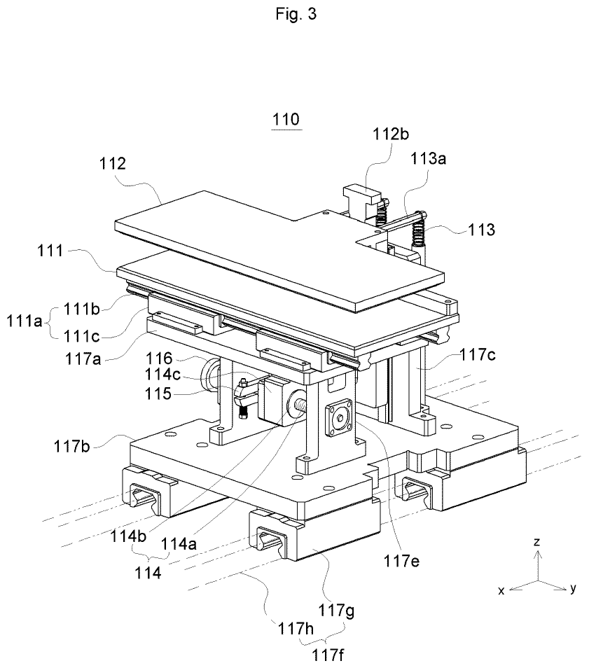

FIG. 2 is an exploded perspective view of the carrier shown in FIG. 1. FIG. 3 is a perspective view of the carrier shown in FIG. 2 viewed from a different direction.

Referring to FIGS. 2 and 3, in some embodiments, the carrier 110 may include first and second panels 111 and 112. The first panel 111 may be provided to seat and support the electrode assembly 10, and the second panel 112 may be disposed above the first panel 111 to sandwich the electrode assembly 10 between the second panel 112 and the first panel 111. That is, the electrode assembly 10 may be disposed and supported between the first and second panels 111 and 112.

In some embodiments, the first panel 111 may be provided to be laterally movable relative to the second panel 112. Accordingly, the first panel 111 may be provided to adjust the lateral position of the electrode assembly 10 seated thereon. Specifically, in the illustrated embodiment, the first panel 111 may be provided to be movable left and right. The first panel 111 may be fastened to a lower first base 117a through a first linear guide 111a, and the first linear guide 111a may include a rail 111b extending left and right and a carriage 111c moving along the rail 111b, and may be provided to be movable left and right relative to the first base 117a.

Meanwhile, in some embodiments, the second panel 112 may be provided to be vertically movable relative to the first panel 111. Through this, the second panel 112 may sandwich the electrode assembly 10 seated on the first panel 111, or may be separated from the electrode assembly 10 to release the fixing of the electrode assembly 10. That is, the second panel 112 may be provided to descend toward the electrode assembly 10 to fix the electrode assembly 10 or to ascend from the electrode assembly 10 to release the fixing of the electrode assembly 10.

In some embodiments, the second panel 112 may be provided to be movable vertically through a second linear guide 112a. In the illustrated embodiment, the second linear guide 112a may be vertically disposed to mediate the coupling between first and second brackets 117c and 117d. In addition, the first bracket 117c may be fastened to a lower second base 117b and the second bracket 117d may be fastened to the second panel 112 so that the second panel 112 is able to move up and down through the second linear guide 112a.

Meanwhile, in some embodiments, the second panel 112 may be elastically supported toward the first panel 111. The second panel 112 may more appropriately fix the electrode assembly 10 between itself and the first panel 111. Specifically, the second panel 112 may be elastically supported by a first spring 113, and the first spring 113 may be provided to apply a predetermined downward elastic restoring force to the second panel 112. Accordingly, the second panel 112 may be elastically supported toward the first panel 111. In some embodiments, the first spring 113 may be provided as a tension coil spring 113. In the illustrated embodiment, a pair of tension coil springs 113 are provided on left and right sides. A lower end of the tension coil spring 113 may be fixed and an upper end thereof may be coupled to a rod 113a. Also, the rod 113a may extend in the front-rear direction and may be coupled to the second bracket 117d. Accordingly, the second panel 112 fastened to the second bracket 117d may be elastically supported downward through the tension coil spring 113.

In some embodiments, the second panel 112 or the second bracket 117d supported by the second panel 112 may be provided with a grip 112b for coupling an operating mechanism or the like. In the illustrated embodiment, the grip 112b is exemplified as being provided on an upper end of the second bracket 117d. For reference, the operating mechanism coupled to the grip 112b is omitted from the illustration. The grip 112b allows the operating mechanism or the like to separate the second panel 112 from the first panel 111. That is, the operating mechanism or the like may separate the second panel 112 from the first panel 111 against the elastic force of the first spring 113 by holding the grip 112b and lifting the second panel 112 upward.

Meanwhile, in some embodiments, the carrier 110 may include a ball screw 114 for adjusting the position of the first panel 111. The ball screw 114 may be provided to be able to adjust the lateral position of the first panel 111. Accordingly, the lateral position of the electrode assembly 10 seated on the first panel 111 may be appropriately adjusted.

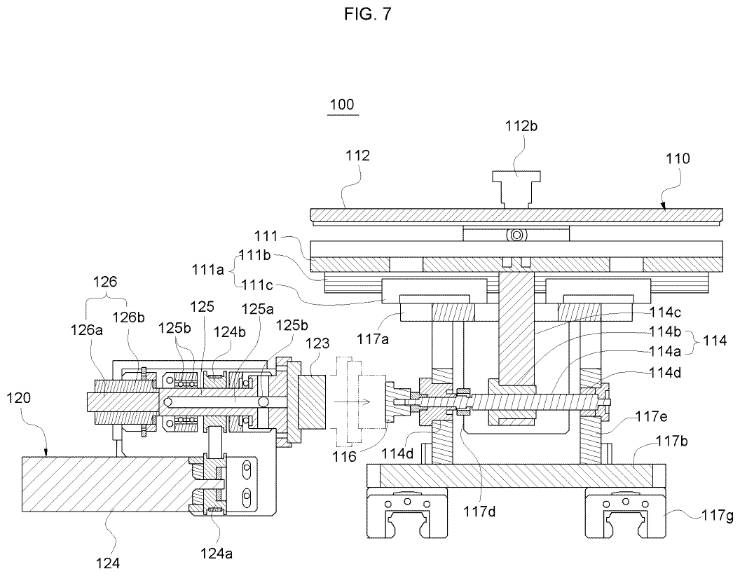

Specifically, focusing on the illustrated embodiment, the above-described first panel 111 may be provided above the first base 117a to be movable left and right through the first linear guide 111a. In addition, the first base 117a may be supported above the second base 117b through a third bracket 117e. A pair of third brackets 117e may be provided to be spaced apart from each other in the left-right direction, and the ball screw 114 may be disposed in the left-right direction between the pair of third brackets 117e. The ball screw 114 may include a screw shaft 114a that extends left and right and is rotatably supported by the pair of third brackets 117e in the longitudinal direction, and a nut 114b that is screw-coupled to the screw shaft 114a. The nut 114b may be provided so that the left-right position thereof is adjusted according to the rotation of the screw shaft 114a. In addition, the nut 114b may be coupled to a link 114c, and the link 114c may extend toward the upper first panel 111 and may be coupled to the first panel 111 (see FIG. 7). Accordingly, the nut 114b and the link 114c may move the first panel 111 left and right. That is, the first panel 111 may be positioned left and right according to the left and right movement of the nut 114b according to the rotation of the screw shaft 114a.

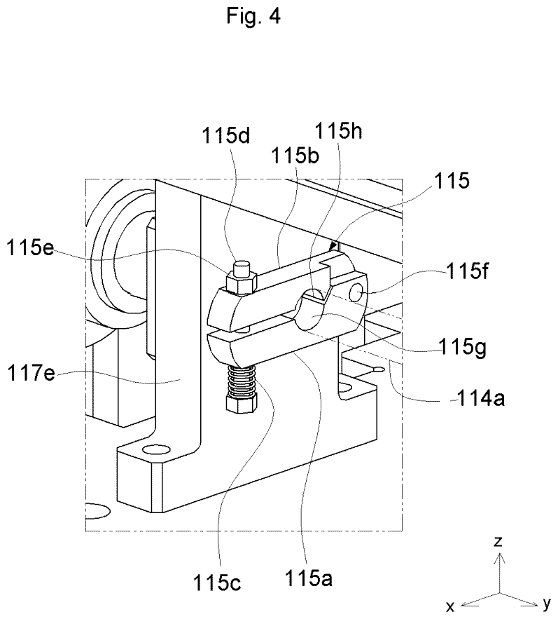

Meanwhile, in some embodiments, the carrier 110 may include a preload unit 115. The preload unit 115 may be provided to come into frictional contact with an outer surface of the ball screw 114 to restrict unnecessary rotation of the ball screw 114. In other words, the preload unit 115 may be provided to limit unintentional rotation of the ball screw 114 by an external force during the process when no rotational driving force is applied to the ball screw 114. The detailed configuration of the preload unit 115 will be further described with reference to FIG. 4 to be described below.

Meanwhile, in some embodiments, the carrier 110 may include a socket 116 transmitting a rotational driving force to the ball screw 114. The socket 116 may be provided at one end of the ball screw 114 facing the alignment device 120. The socket 116 may be provided to be constrained and fixed to the ball screw 114 to rotate together with the ball screw 114. In addition, the socket 116 may be provided to be selectively coupled to the alignment device 120. That is, the socket 116 may be coupled to the alignment device 120 or separably provided from the alignment device 120. The socket 116 may be coupled to the alignment device 120 to align the position of the electrode assembly 10. The socket 116 may transmit a rotational driving force provided from the alignment device 120 to the ball screw 114, and the positions of the first panel 111 and the electrode assembly 10 may be adjusted according to the rotation of the ball screw 114. In addition, the socket 116 may be separated from the alignment device 120 to allow movement of the carrier 110. In the illustrated embodiment, the socket 116 may be coupled to the alignment device 120 or separated from the alignment device 120 according to the left-right movement of the alignment device 120.

In some embodiments, the socket 116 may be magnetically coupled to the alignment device 120. The magnetic coupling allows selective coupling between the socket 116 and the alignment device 120 to be implemented more easily. That is, the magnetic coupling may implement easy attachment and detachment between the socket 116 and the alignment device 120. Additionally, in some embodiments, the socket 116 may have a coupled surface 116a that is magnetically coupled to the alignment device 120, and the coupled surface 116a may be provided to have a relatively large cross-sectional area compared to that of the screw shaft 114a of the ball screw 114. For example, in the illustrated embodiment, the screw shaft 114a has a circular cross-section with a first diameter, and the coupled surface 116a has a circular cross-section with a second diameter larger than the first diameter. Such a coupled surface 116a may contribute to properly maintaining the coupled state between the alignment device 120 and the screw shaft 114a when the alignment device 120 rotates the screw shaft 114a. That is, the rotational torque transmitted from the screw shaft 114a may be properly supported through the magnetic coupling force of the coupled surface 116a and slippage or operational errors on the coupled surface 116a may be reduced.

Meanwhile, in some embodiments, the carrier 110 may include the first and second bases 117a and 117b. The first base 117a may be disposed under the first panel 111 to support the first panel 111. The first panel 111 may be fastened to the first base 117a through the first linear guide 111a and may be provided to be movable left and right relative to the first base 117a. The second base 117b may be disposed under the first base 117a. The first base 117a may be supported above the second base 117b through the third bracket 117e. As described above, the pair of third brackets 117e may be provided on left and right sides, and the ball screw 114 may be coupled to the pair of third brackets 117e. Also, the first bracket 117c may be disposed behind the third bracket 117e. As described above, the second panel 112 may be vertically supported by the first bracket 117c through the second linear guide 112a.

The second base 117b may be provided to be movable in the front-rear direction through a third linear guide 117f. In the illustrated embodiment, the third linear guide 117f is disposed on a lower surface of the second base 117b and composed of a pair of rails 117h spaced apart from each other in the left-right direction, and four carriages 117g spaced apart from each other in the front-rear and left-right directions. The second base 117b and the carrier 110 may be moved to each process operation through the third linear guide 117f.

FIG. 4 is an enlarged view of the preload unit shown in FIG. 3.

Referring to FIG. 4, in some embodiments, the carrier 110 may include the preload unit 115 to partially restrict the rotation of the ball screw 114. In the illustrated embodiment, the preload unit 115 is disposed at a left side end portion of the screw shaft 114a.

In some embodiments, the preload unit 115 may include first and second preload unit bodies 115a and 115b, a second spring 115c, an adjusting bolt 115d, and an adjusting nut 115e. The first and second preload unit bodies 115a and 115b may be rotatably coupled through a hinge shaft 115f. In addition, first and second clamping grooves 115g and 115h may be provided on facing surfaces of the first and second preload unit bodies 115a and 115b, respectively. The first and second clamping grooves 115g and 115h may be provided in a groove shape corresponding to the shape of the outer surface of the screw shaft 114a of the ball screw 114 and may come into pressurized contact with the outer surface of the screw shaft 114a. Accordingly, the screw shaft 114a may come into frictional contact with the first and second clamping grooves 115g and 115h, thereby restricting unnecessary rotation. That is, the screw shaft 114a may be properly rotated when an operating force is applied by the alignment device 120 to be described below.

The second spring 115c may be provided to elastically support the first preload unit body 115a. In the illustrated embodiment, the second spring 115c is exemplified as a compression coil spring 115c that elastically supports the first preload unit body 115a upward. The first preload unit body 115a may be brought into elastic contact with the outer surface of the ball screw 114 by an elastic support force of the second spring 115c. That is, the first clamping groove 115g provided in the first preload unit body 115a may be brought into elastic contact with an outer surface of the screw shaft 114a of the ball screw 114. For reference, the screw shaft 114a may have a central region where a screw thread is provided for screw coupling with the carrier 110 and an end portion region where the screw thread is omitted, and the first and second clamping grooves 115g and 115h may come into frictional contact with the end portion region.

Meanwhile, the adjusting bolt 115d may be provided to vertically pass through the first and second preload unit bodies 115a and 115b at a position spaced apart from the hinge shaft 115f. The adjusting bolt 115d may have the adjusting nut 115e at one end thereof, and the adjusting nut 115e may be provided to come into contact with the second preload unit body 115b and regulate the position of the second preload unit body 115b. The adjusting bolt 115d and the adjusting nut 115e regulate the position of the second preload unit body 115b so that a frictional force applied to the outer surface of the ball screw 114 may be adjusted. That is, the adjusting bolt 115d and the adjusting nut 115e may be provided to adjust a pressing force applied to the screw shaft 114a between the first and second clamping grooves 115g and 115h according to the position of the adjusting nut 115e.

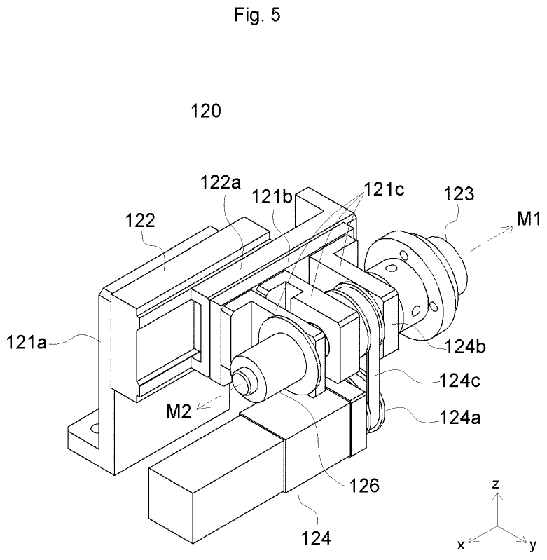

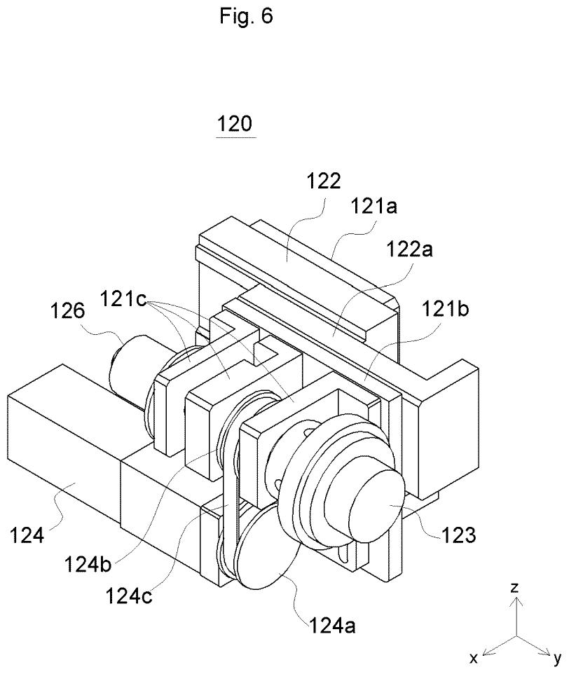

FIG. 5 is an exploded perspective view of the alignment device shown in FIG. 1. FIG. 6 is a perspective view of the alignment device shown in FIG. 5 viewed from a different direction.

Referring to FIGS. 5 and 6, in some embodiments, the alignment device 120 may move back and forth from/toward the carrier 110 so as to be selectively coupled to the carrier 110. That is, the alignment device 120 may move forward (M1) toward the carrier 110 to be coupled to the carrier 110 or may move backward (M2) to be properly separated from the carrier 110.

Specifically, focusing on the illustrated embodiment, the alignment device 120 may include a third base 121a fixed to the installation surface, and an actuator 122 that operates left and right may be provided on the third base 121a. The actuator 122 may be fastened to a fourth bracket 121b through a fourth linear guide 122a, and the fourth linear guide 122a may be provided to guide the forward and backward movement of the fourth bracket 121b in the left-right direction. Meanwhile, an electromagnet 123, or the like, which will be described below, may be disposed on the fourth bracket 121b through a fixed block 121c. Accordingly, the electromagnet 123 or the like may move forward and backward toward/from the carrier 110 according to the left-right movement of the fourth bracket 121b. In addition, in the alignment device 120, the electromagnet 123 may be coupled to the socket 116 of the carrier 110 or properly separated from the socket 116.

Meanwhile, in some embodiments, the alignment device 120 may include the electromagnet 123. The electromagnet 123 may be selectively magnetically coupled to the socket 116 of the ball screw 114 described above. That is, the electromagnet 123 may be magnetically coupled to the socket 116 or appropriately separated from the socket 116 according to the movement of the alignment device 120. In addition, the electromagnet 123 may be coupled to the socket 116 to transmit the rotational driving force of the alignment device 120 to the socket 116. Accordingly, the socket 116 and the screw shaft 114a may be appropriately driven to rotate. In addition, the electromagnet 123 may be separated from the socket 116 when positional alignment is completed, and the carrier 110 may move to the next process operation.

In some embodiments, the alignment device 120 may include a servo motor 124 that rotates the electromagnet 123. The servo motor 124 may be linked to the electromagnet 123 to provide a rotational driving force to the electromagnet 123. In the illustrated embodiment, the servo motor 124 is linked to the electromagnet 123 through first and second sprockets 124a and 124b and a belt 124c. Specifically, the first sprocket 124a may be provided on a drive shaft of the servo motor 124, and the first sprocket 124a may be driven and connected to the second sprocket 124b through the belt 124c. The second sprocket 124b may be rotatably supported by the fixed block 121c, and may be coupled to the electromagnet 123 through a rotating shaft 125 to transmit the rotational driving force to the electromagnet 123 (see FIG. 7).

FIG. 7 is a longitudinal-sectional view of the secondary battery manufacturing device shown in FIG. 1.

Referring to FIG. 7, in some embodiments, the alignment device 120 may include the rotating shaft 125. The rotating shaft 125 may extend in the left-right direction and may be rotatably supported by the fixed block 121c through a bearing 125b. The rotating shaft 125 may be rotatably driven in the longitudinal direction through a driving force provided from the servo motor 124.

In addition, the electromagnet 123 may be provided at an end portion of the rotating shaft 125. The electromagnet 123 may be fixed to one end of the rotating shaft 125 so as to rotate integrally with the rotating shaft 125. In addition, as described above, the electromagnet 123 may move forward and backward in the left-right direction according to the operation of the actuator 122 and may be attached and detached to/from the socket 116. The electromagnet 123 may be magnetically coupled to the socket 116 while in contact with the socket 116, and may transmit a rotational driving force to the socket 116 and the screw shaft 114a. In addition, the screw shaft 114a may be rotatably supported by the third bracket 117e through a bushing 114d and may rotate according to the rotation of the electromagnet 123. Accordingly, the ball screw 114 may appropriately adjust the left-right position of the first panel 111.

In some embodiments, a wiring path 125a may be provided inside the rotating shaft 125. The wiring path 125a may be used as a wiring channel for supplying power to the electromagnet 123. That is, the electromagnet 123 may be connected to a slip ring 126 to be described below through the wiring path 125a to be supplied with power from the outside.

Meanwhile, in some embodiments, the alignment device 120 may include the slip ring 126 provided at one end of the rotating shaft 125. The slip ring 126 may be provided to supply power provided from the outside to the electromagnet 123. The slip ring 126 may include a rotating portion 126a coupled to the rotating shaft 125 and rotating in conjunction with the rotating shaft 125, and a fixed portion 126b that rotatably supports the rotating portion 126a. Although not shown, a wiring for power supply may be connected to the fixed portion 126b, and the rotating portion 126a may be electrically connected to the fixed portion 126b to supply power provided to the fixed portion 126b to the electromagnet 123. Since an internal configuration of the slip ring 126 has been variously disclosed in the art, a more detailed description thereof will be omitted.

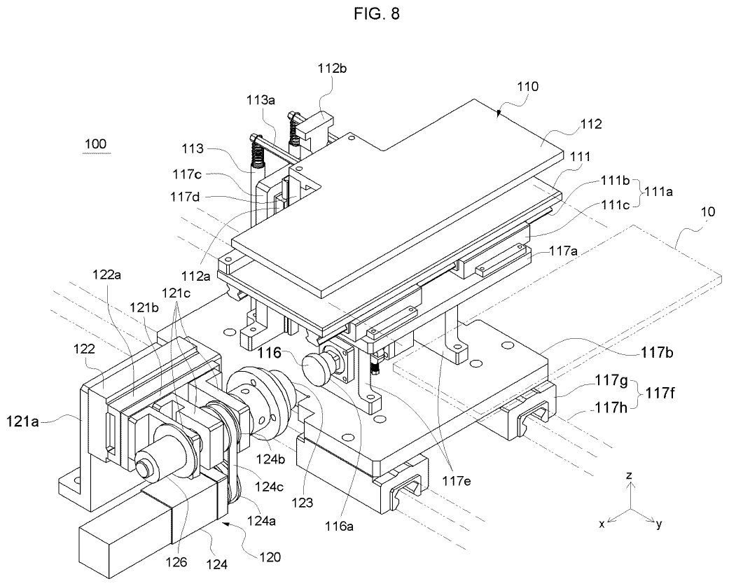

FIGS. 8 to 10 are operational state views of the secondary battery manufacturing apparatus shown in FIG. 1.

Referring to FIG. 8, first, the second panel 112 may move upward, and the electrode assembly 10 may be inserted onto an upper surface of the first panel 111. The electrode assembly 10 which is inserted may be seated and supported on the first panel 111. Subsequently, the second panel 112 may be returned to its original position by the first spring 113, and the electrode assembly 10 may be sandwiched between the first and second panels 111 and 112. The carrier 110 may move to each process operation with the electrode assembly 10 sandwiched between the first and second panels 111 and 112. Meanwhile, the alignment device 120 may be disposed in a state of being separated from the carrier 110.

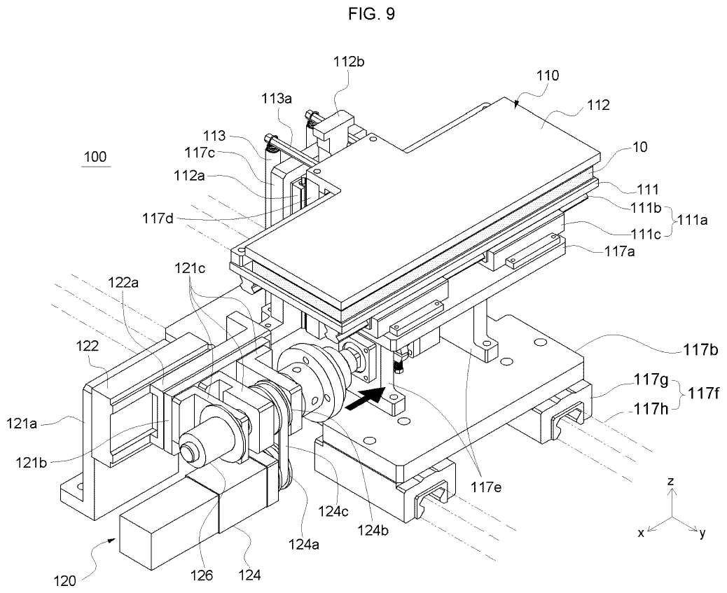

Referring to FIG. 9, the alignment device 120 may be coupled to the carrier 110 for positional alignment of the electrode assembly 10. Specifically, when the carrier 110 is stopped at a position corresponding to the alignment device 120, the actuator 122 may move the fourth bracket 121b toward the carrier 110. Accordingly, the electromagnet 123 may be moved toward the socket 116 and coupled to the socket 116. In addition, the electromagnet 123 may be supplied with power through the slip ring 126, and the electromagnet 123 may be magnetically coupled to the socket 116. Accordingly, the socket 116 and the ball screw 114 may be prepared to rotate together with the electromagnet 123.

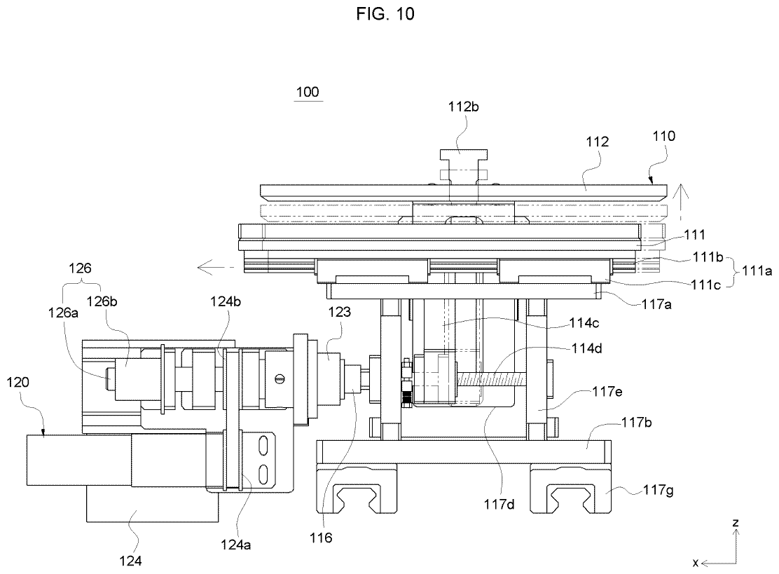

Referring to FIG. 10, the position of the electrode assembly 10 may then be aligned. FIG. 10 exemplifies a case in which the electrode assembly 10 is moved a predetermined distance to the left to align the position. Specifically, first, the second panel 112 holding the electrode assembly 10 may be opened upward. That is, the first and second panels 111 and 112 may be spaced apart from each other, and the electrode assembly 10 may be disposed while being seated on the first panel 111. Accordingly, the first panel 111 and the electrode assembly 10 are movable left and right relative to the second panel 112.

Thereafter, the electromagnet 123 may be rotated by a predetermined angle through the servo motor 124. That is, the servo motor 124 rotates the rotating shaft 125 through the first and second sprockets 124a and 124b and the belt 124c, and accordingly, the electromagnet 123 may rotate. The rotation angle of the servo motor 124 may be appropriately determined according to the required displacement or the like. For example, the left-right position of the electrode assembly 10 may be determined through a vision camera, and compared with a predetermined reference position to appropriately determine the movement distance of the electrode assembly 10 or the rotation angle of the servo motor 124.

When the electromagnet 123 rotates a predetermined angle as described above, the socket 116 and the screw shaft 114a magnetically coupled to the electromagnet 123 rotate in conjunction therewith, and the nut 114b and the link 114c may move a predetermined distance left and right depending on the rotation angle. That is, in the illustrated operation example, the nut 114b and the link 114c may move a predetermined distance to the left. In addition, the first panel 111 and the electrode assembly 10 may move a predetermined distance to the left and right by the link 114c. For reference, since the second panel 112 is disposed above the first panel 111 and supported by the second base 117b through the first bracket 117c, the second panel 112 may be separated without being affected by the left-right movement of the first panel 111 as described above.

Meanwhile, when the electrode assembly 10 is properly positioned at the set position, the second panel 112 may be returned to its original position by the first spring 113, and the electrode assembly 10 may be sandwiched again between the first and second panels 111 and 112 at the adjusted position. In addition, the carrier 110 can be used to move the position-adjusted electrode assembly 10 to each process operation.

As described above, embodiments of the present disclosure may provide a secondary battery manufacturing device.

In addition, some embodiments of the present disclosure may be appropriately used for transferring an electrode assembly in the secondary battery manufacturing process.

In addition, some embodiments of the present disclosure may provide a positional alignment function for the disposed electrode assembly while transferring the electrode assembly to each process operation. Accordingly, each process operation may be performed at the aligned position, and generation of defective products or quality degradation due to a positional error of the electrode assembly may be prevented.

In addition, in some embodiments of the present disclosure, the position of the electrode assembly may be aligned by moving the first panel on which the electrode assembly is seated. That is, some embodiments of the present disclosure may minimize the physical contact between the alignment means or the like and the electrode assembly. Accordingly, damage to the electrode assembly due to contact with the alignment means may be prevented in advance. In addition, such non-contact positional alignment may function more effectively for an electrode assembly in the form of a flexible sheet.

Embodiments of the present disclosure can provide a secondary battery manufacturing device.

In addition, some embodiments of the present disclosure can be appropriately used for transferring an electrode assembly in a secondary battery manufacturing process.

In addition, some embodiments of the present disclosure can properly align the position of an electrode assembly in an electrode assembly manufacturing process.

In addition, some embodiments of the present disclosure can prevent damage to an electrode assembly in an electrode assembly manufacturing process.

The above description is only an example to which the principle of the present disclosure is applied, and other configurations may be further included without departing from the scope of the present disclosure.

Although the embodiments of the present disclosure have been described above, those with ordinary knowledge in the art will be able to modify or change the present disclosure in various ways by adding, changing, deleting, or adding components without departing from the scope of the present disclosure, and such modifications and changes are within the scope of the present disclosure.

What is claimed is:

1. A secondary battery manufacturing device comprising:
a carrier on which the electrode assembly is seated and disposed; and
an alignment device selectively coupled to the carrier to align a position of the electrode assembly.

2. The secondary battery manufacturing device of claim 1, wherein the carrier includes:
a first panel on which the electrode assembly is seated; and
a second panel sandwiching the electrode assembly between the first panel and the second panel.

3. The secondary battery manufacturing device of claim 2, wherein the first panel is provided to be laterally movable relative to the second panel.

4. The secondary battery manufacturing device of claim 2, wherein the second panel is provided to be vertically movable relative to the first panel.

5. The secondary battery manufacturing device of claim 2, wherein the second panel is elastically supported toward the first panel so as to elastically support the electrode assembly between the first panel and the second panel.

6. The secondary battery manufacturing device of claim 2, wherein the carrier includes a ball screw connected to the first panel through a link and moving the first panel laterally.

7. The secondary battery manufacturing device of claim 6, wherein the carrier includes a preload unit that comes into frictional contact with an outer surface of the ball screw to partially restrict the rotation of the ball screw.

8. The secondary battery manufacturing device of claim 7, wherein the preload unit includes:
first and second preload unit bodies coupled through a hinge shaft and clamping the outer surface of the ball screw;
a second spring elastically supporting the first preload unit body toward the outer surface of the ball screw; and
an adjusting bolt and an adjusting nut that regulate a position of the second preload unit body to adjust a frictional force applied to the outer surface of the ball screw.

9. The secondary battery manufacturing device of claim 6, wherein the carrier includes a socket selectively coupled to the alignment device and transmitting a rotational driving force to the ball screw.

10. The secondary battery manufacturing device of claim 1, wherein the carrier includes:
a first base supporting a first panel on which the electrode assembly is seated; and
a second base supporting a second panel that sandwiches the electrode assembly between the first panel and the second panel.

11. The secondary battery manufacturing device of claim 10, wherein the second base is provided to be movable relative to the alignment device.

12. The secondary battery manufacturing device of claim 1, wherein the alignment device is provided to be movable forward and backward toward/from the carrier and is selectively coupled to the carrier.

13. The secondary battery manufacturing device of claim 1, wherein the alignment device includes an electromagnet selectively magnetically coupled to a socket of a ball screw provided in the carrier.

14. The secondary battery manufacturing device of claim 13, wherein the alignment device includes a rotating shaft that rotates the electromagnet so that the ball screw rotates about a longitudinal direction as an axis.

15. The secondary battery manufacturing device of claim 14, wherein the rotating shaft is provided with a wiring path therein to supply power to the electromagnet.

16. The secondary battery manufacturing device of claim 14, wherein the alignment device includes a slip ring provided on the rotating shaft,
wherein the slip ring includes a rotating portion that rotates in conjunction with the rotating shaft and a fixed portion that rotatably supports the rotating portion.
